(19) United States
(12) Patent Application Publication
(10) Pub. No.: US 2024/0253493 A1
(43) Pub. Date: Aug. 1, 2024

(54) ELECTRIC VEHICLE CHARGING STATION WITH RELEASE MECHANISM

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/430,576

(22) Filed: Feb. 1, 2024

Related U.S. Application Data
(60) Provisional application No. 63/442,626, filed on Feb. 1, 2023.

(51) Int. Cl. B60L 53/30; B60L 53/18

(52) U.S. Cl. CPC B60L 53/30; B60L 53/18

(57) ABSTRACT

One or more examples provide an electric vehicle or a device for use with an electric vehicle, including an electric vehicle charging system and method. The charging system includes an electric vehicle charging station with a release mechanism.

### CROSS REFERENCE TO RELATED APPLICATIONS

This Non-Provisional patent application claims the benefit of the filing date of U.S. Provisional Patent Application Ser. No. 63/442,626, filed Feb. 1, 2023, which is herein incorporated by reference.

### TECHNICAL FIELD

The present disclosure relates generally to examples of electric vehicles and to devices for use with an electric vehicle, including electric vehicle batteries and electric vehicle charging systems and devices.

### BACKGROUND

Electric vehicles and electric vehicle devices provide quiet, clean, and efficient powertrains for moving from place to place or for getting work done.

For these and other reasons, there is a need for the present invention.

### SUMMARY

The present disclosure provides one or more examples of an electric vehicle and systems and/or devices for use with an electric vehicle. In one or more examples, the system is an electric vehicle charging system and/or charging device.

In one example in accordance with the present disclosure, an electric vehicle charging station is provided. The electric vehicle charging station includes a housing, where the housing is a longitudinally extending housing. One or more charging components are coupled to the housing. A release mechanism is located along the housing; where upon impact to the housing the housing separates at the release mechanism. In other examples, a charging facility is disclosed herein, including one or more charging stations having a release mechanism.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems and devices.

FIG. 1 is a diagram generally illustrating an electric vehicle charging station, according to examples of the present disclosure.

FIG. 2 is a diagram illustrating an electric vehicle charging station, according to examples of the present disclosure.

FIG. 3 is a diagram generally illustrating an electric vehicle charging station, according to examples of the present disclosure.

FIG. 4 is a diagram illustrating an electric vehicle charging station, according to examples of the present disclosure.

FIGS. 5A-5D illustrate a release mechanism for use with an electric vehicle charging station, according to examples of the present disclosure.

FIG. 6 is a diagram generally illustrating an electric vehicle charging station, according to examples of the present disclosure.

FIG. 7 is a diagram illustrating an electric vehicle charging station, according to examples of the present disclosure.

FIG. 8 is a diagram generally illustrating an electric vehicle charging station, according to examples of the present disclosure.

FIG. 9 is a diagram illustrating an electric vehicle charging station, according to examples of the present disclosure.

FIG. 10 is a diagram generally illustrating an electric vehicle charging station, according to examples of the present disclosure.

FIG. 11 is a diagram illustrating an electric vehicle charging station, according to examples of the present disclosure.

FIG. 12 is a diagram illustrating an electric vehicle charging station, according to examples of the present disclosure.

FIG. 13 is a diagram illustrating an electric vehicle charging station, according to examples of the present disclosure.

FIG. 14 is a diagram illustrating an electric vehicle charging station, according to examples of the present disclosure.

FIG. 15 is a diagram illustrating an electric vehicle charging station, according to examples of the present disclosure.

FIG. 16 is a diagram illustrating an electric vehicle charging station, according to examples of the present disclosure.

FIG. 17 is a diagram illustrating an electric vehicle charging station, according to examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), autonomous vehicles, watercraft, all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

Electric Vehicle Charging Station with Release Mechanism

The present disclosure provides an EV charging system for simultaneously charging multiple EVs. The charging system includes a charging station with a release mechanism. Upon occurrence of a force impact to the charging station, the charging station reacts to the impact in a predetermined manner to minimize the effect on the charging station.

Charging stations are employed between charging spaces or at the end of a charging space, often without adequate protection from being hit by a vehicle moving into position for being charged. If a charging station is hit by a vehicle, the release mechanism provides for the charging station to take the impact of a vehicle in a predetermined manner thereby minimizing any resulting damage to the charging station from the vehicle.

The EV charging station may be employed in any suitable charging facility. Examples of such charging facilities include surface lot charging facilities, parking ramps, parking facilities, and charging stations (e.g., an EV charging facility with convenience store). The charging facility may be employed both as part of newly constructed parking facilities or adapted for use in existing parking facilities. The parking facility may be most any type of parking facility, such as a public parking facility (e.g., shopping centers), a corporate parking facility (e.g., associated with a business, such as manufacturing facility or a hotel), and a commercial parking facility (e.g., a pay facility)—any type of parking facility where EVs will be parked for extended time periods (e.g., for a half hour or more) while the drivers are occupied with other tasks (e.g., shopping, dining, attending a sporting event, working, etc.). In examples, the parking facility may include parking for both EVs and non-electric vehicles.

One or more examples and features of the charging system are detailed herein and illustrated in the Figures.

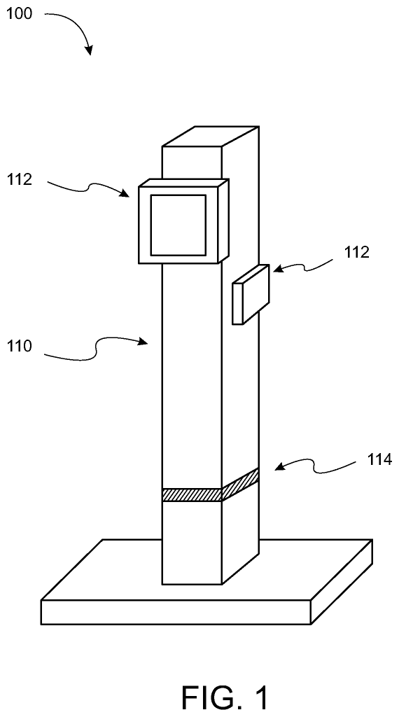

FIG. 1 is a diagram generally illustrating an electric vehicle charging station at 100, according to examples of the present disclosure. The charging station 100 includes a housing 110. The housing 110 is a longitudinally extending housing. One or more charging components 112 are coupled to the housing 110. A release mechanism 114 is provided along the housing 110. In one example, the release mechanism 114 is a weakened area at a predefined area location in the housing 110. Upon impact to the housing 110, the housing 110 separates at the release mechanism 114. In one example, the release mechanism 114 separates the housing 110 into two separate pieces. Examples of release mechanism 114 are detailed in this specification.

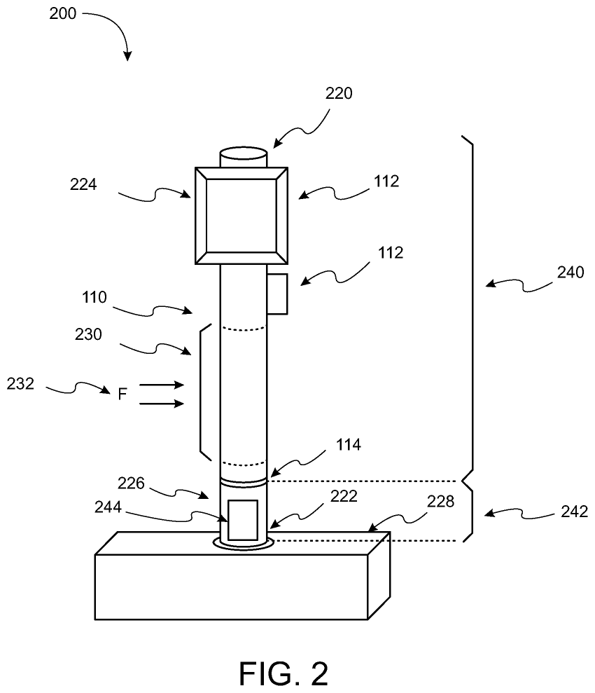

FIG. 2 is a diagram illustrating an electric vehicle charging station 200, according to examples of the present disclosure. The electric vehicle charging station 200 is similar to the electric vehicle charging station 100 previously described herein.

In examples, the charging station 200 housing 110 includes a first end 220 and a second end 222. A user interface 224 (e.g., a graphical user interface) is located near the first end 220. A base unit 226 is located near or at the second end 222. In one example, base unit 226 is a sealed base unit and is coupled to a support structure 228. The release mechanism 114 is located near base unit 226 and between the base unit 226 and the first end 220.

The release mechanism 114 can be formed integral to the housing 110. The release mechanism 114 can be formed of a material different from the housing 110. For example, the housing 110 can be formed of a first material and the release mechanism 114 can be formed of a second material where the second material is structurally weaker than the first material. In one example, the second material is primarily structurally weaker than the first material in a horizontal force direction relative to a ground plane.

The housing 110 includes a vehicle contact zone 230. The vehicle contact zone 230 is located above the release mechanism 114. The vehicle contact zone 230 is an area on the housing 110 located within a range of a vehicle crash height and is capable of withstanding an impact force 232 from an electric vehicle. In one example operation, if an electric vehicle were to accidentally impact the charging station 200, the impact force 232 on the charging station 200 occurs in a generally horizontal direction within the vehicle contact zone 230. If an accident were to occur, the charging station 200 separates only at the predetermined location of the release mechanism 114. This maintains the integrity of the charging station 200 and minimizes any damage to the charging station 200.

In examples, vehicle contact zone 230 is made of a material strong enough to withstand an impact force 232. Vehicle contact zone 230 can include an extra material layer to make it stronger than the area outside of the vehicle contact zone 230. Vehicle contact zone can be made of a puncture proof, dent proof material (e.g., a polymeric material) to minimize damage to the charging station 200 upon impact from an outside force such as a vehicle crash.

In one example illustrated, upon impact of a force to charging station 200, the charging station 200 separates at the release mechanism 114 predefined location maintaining the integrity of the charging station 200. As such, upon occurrence of an impact force 232 to the charging station 200 (e.g., a vehicle crashing into the charging station), the charging station 200 reacts to the impact force in a predetermined manner to minimize the effect on (e.g., damage to) the charging station 200.

In examples, the charging station 200 includes an upper section 240 and a lower section 242. The upper section 240 is located above release mechanism 114 and the lower section 242 is located below release mechanism 114. Upon impact force 232 hitting charging station 200, the charging station 200 separates at release mechanism 114 into two separate sections, upper section 240 and lower section 242.

The lower section 242 includes base unit 226. After impact, the base unit 226 remains in place coupled to support structure 228 unharmed. In examples, base unit 228 is a sealed structure. Since base unit 228 is not damaged, charging station components 244 are located in base unit 126. For example, charging station components can include a control system, electric sensors, electrical detectors, a heater, etc. Minimal components are located in upper section 240, such as user interface 224.

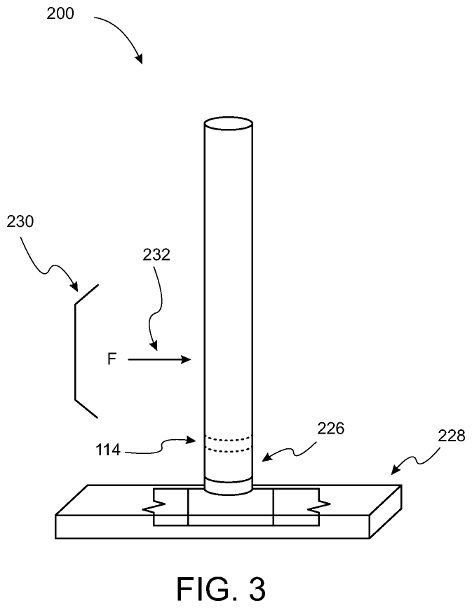

FIGS. 3-5 are diagrams generally illustrating how an electric vehicle charging station having a release mechanism reacts to an impact force, according to examples of the present disclosure.

FIG. 3 is a diagram of charging station 200 just prior to receiving an impact force (e.g., due to a crash). Charging station 200 is shown without charging components 112 for ease of illustration. An impact force 232 is directed at the vehicle contact zone 230 (e.g., crash zone). As illustrated, the charging station has been designed to withstand an impact force within the vehicle contact zone 230. The charging station 200 has been designed to respond to the impact force in a predetermined manner. In one example, the charging station has been designed to separate at the release mechanism 114 into separate pieces.

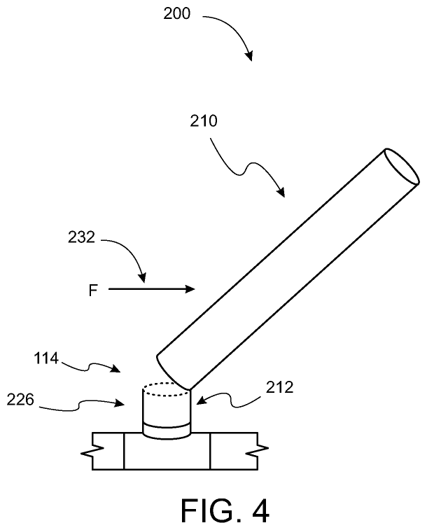

FIG. 4 is a diagram illustrating charging station 200 just after receiving an impact force 232 to vehicle contact zone 230. The charging station 200 reacts to the impact force 232 in a predetermined manner. The charging station 200 separates into two pieces. Housing 110 separates into first section 210 and second section 212. The release mechanism 114 operates as a sheer mechanism or a breakaway location on housing 110. In one example, release mechanism 114 operates to separate housing 110 into two completely separate pieces. In another example, release mechanism 114 operates as a hinge to separate housing 110.

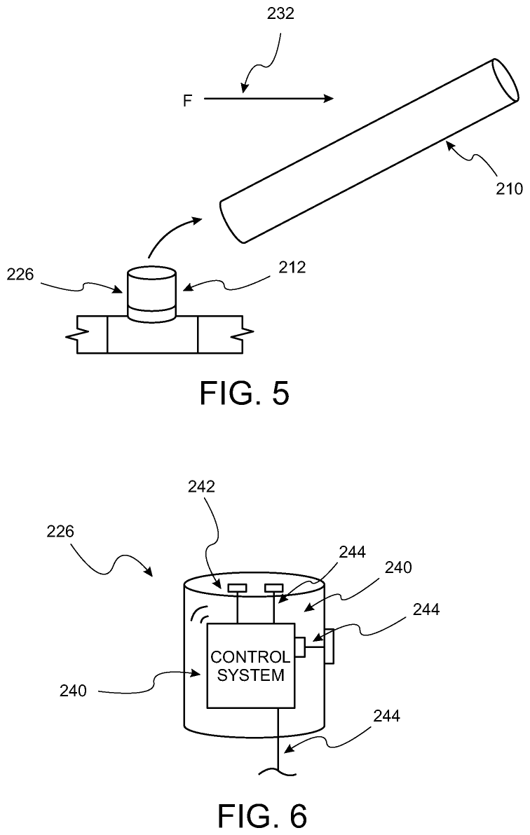

FIG. 5 is a diagram illustrating charging station 200 after the charging station 200 separates into two pieces. In this example, the housing 110 is totally separated at release mechanism 114 into two separate pieces. In this example, the two separate pieces are first section 210 and second section 212. The charging station mechanically separates and electrically separates (i.e., disconnects).

FIG. 6 is a diagram illustrating one example of base unit 226. Base unit 226 is a sealed container and contains most all of the electrical components associated with charging station 110. Even after receiving an impact force to the charging station 200, base unit 226 remains totally intact and can be reconnected to the same or another second section 212. In one example, the base unit 226 includes the charging station 200 control system 240. Control system 240 operates charging station 200, including user interface 224. Control system 240 is coupled to user interface 224 via control wires 242. Alternatively, the communication link between control system 240 and user interface 224 is a wireless communication link. Power cable 244 can also pass through the top 246 of base unit 226 or at the side 248 of base unit 226.

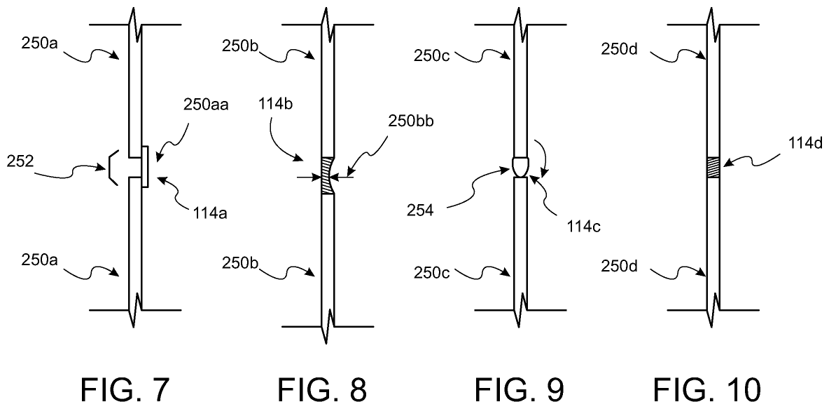

FIGS. 7-10 illustrate examples of the housing 110 sidewall 250 at release mechanism 114.

In FIG. 7, sidewall 250a is illustrated. The release mechanism 114a includes a gap 252 at release mechanism 114a. A second sidewall 250aa is coupled to sidewall 250a across (i.e., bridging) the gap 252. In one example, the sidewall 250aa is made of a weaker material than sidewall 250a. In another example, sidewall 250aa is very thin relative to sidewall 250a.

In FIG. 8, sidewall 250b is illustrated. The release mechanism 114b is formed by a thinning of the sidewall 250b, indicated by sidewall 250bb. This results in release mechanism 114b being much weaker than sidewall 250b. Additionally, sidewall 250bb can be made of a different material than sidewall 250b. In one example, sidewall 250bb is made of a weaker material to form release mechanism 114b than sidewall 250b.

In FIG. 9, sidewall 250c is illustrated. The release mechanism 114c is defined by a hinge mechanism 254c. When hit by an impact force, the hinge mechanism 254c operates to at least partially separate the housing 110c at release mechanism 114c in a predefined manner while maintaining the integrity of the housing 110c.

In FIG. 10, sidewall 250d is illustrated. The release mechanism 114d is formed by a different material than sidewall 250d. The material that makes up release mechanism 114d is much weaker and has less structural integrity than the material making up sidewall 250d. In one example, sidewall 250d is made of a rigid metal material (e.g., steel or aluminum). Release mechanism 114d is made of a generally brittle polymeric material.

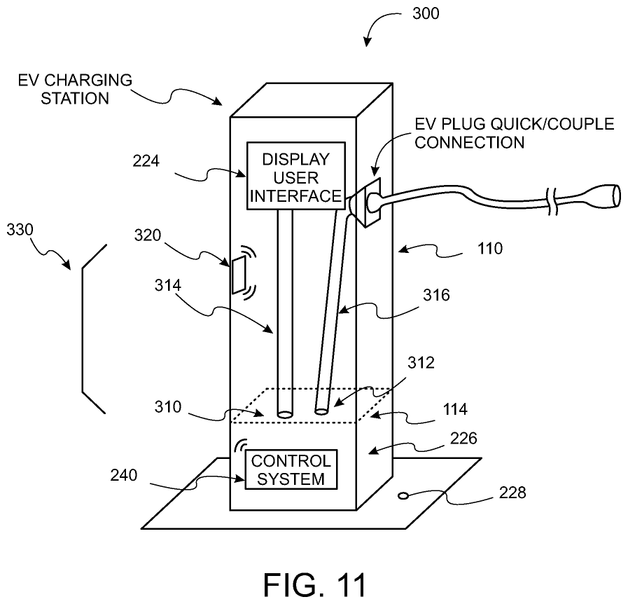

FIG. 11 is a diagram illustrating an electric vehicle charging station 300, according to examples of the present disclosure. The charging station 300 is similar to charging stations described herein. The charging station 300 includes a control quick disconnect 310 and a power quick disconnect 312. Control wires 314 from user interface 224 are electrically coupled to control system xxx at base unit 226 via control quick disconnect 310. Power cable 316 (i.e., charging cable wiring) is electrically connected to the power feed at control system 240 at base unit 226 via power quick disconnect 312. Upon an impact force to charging station 300, the charging station housing 110 is separated at release mechanism 114. Additionally, the control wires 314 are immediately disconnected from base unit 226 at control quick disconnect 310. Power cable 316 is immediately disconnected from base unit 226 at power quick disconnect 312. Alternatively, it is recognized that power cable 316 can be routed externally from base unit 226, an not internally through the housing 110 where a quick disconnect may be required.

Charging station 300 includes additional detectors and/or sensors to aid in maintaining the integrity of charging station 300 should it receive an impact force (e.g., from a vehicle crash). In one example, charging station 300 includes a crash detector 320 (e.g., an accelerometer located in the vehicle contact zone 330). Upon detection of a crash event, crash detector 320 notifies control system 240. Control system 240 operates the charging station 300 to immediately activate a crash protocol. In one example, the crash protocol includes immediately cutting all control power and charging cable power at the charging station 300.

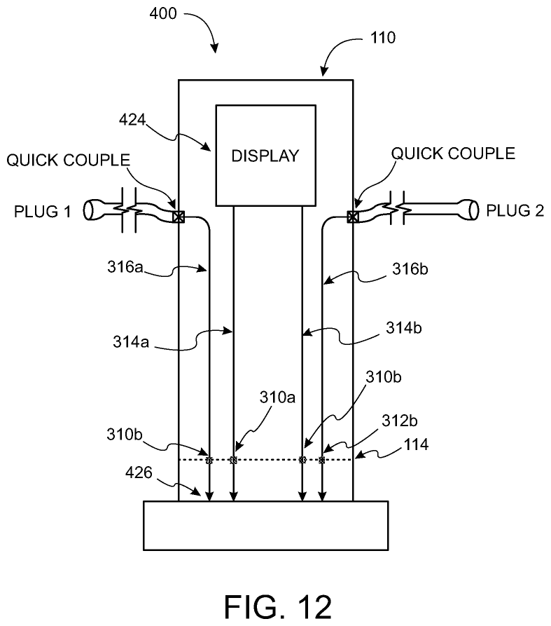

FIG. 12 is a diagram illustrating an electric vehicle charging station 400, according to examples of the present disclosure. The charging station 400 can be similar to charging stations disclosed herein. The charging station 400 is a dual charging station, and includes a release mechanism 114. If an impact force were to occur, the charging station 400 separates only at the predetermined location of the release mechanism 114. This maintains the integrity of the charging station 400 and minimizes any damage to the charging station 400. Further, by locating the control system and other components/electronics to an area below the release mechanism the components can be saved should an accident occur.

Dual charging station 400 includes housing 110 having a first section 410 and a second section 412. The first section 410 is designed such that it includes a minimal amount of components, but does include display/user interface 424. Base unit 426 is located in the second section 412. In one example, base unit 426 is a sealed unit. Most of the charging station components are located in base unit 426, safe from damage should a vehicle crash into the charging station.

Since charging station 400 is a dual charging station it includes dual charging cables, indicated as PLUG1 and PLUG2, and is capable of charging two separate vehicles at once. As such, the charging station 400 includes control cable 314a and power cable 316a associated with PLUG1. The charging station 400 includes control cable 314b and power cable 316b associated with PLUG2. Control cables 314a, 314b are coupled to quick disconnects 310a, 310b where they pass through base unit 426. Power cables 316a, 316b are coupled to quick disconnects 312a, 312b where they pass through base unit 426. In operation, if charging station 400 receives an impact force to housing 110, the charging station 400 separates into two separate pieces at release mechanism 114. Power cables 316a, 316b and control cables 314a, 314b immediately disconnect from base unit 426 at corresponding quick disconnects 310a, 310b, 312a, and 312b. Charging station 400 can also include additional force detectors or sensors to immediately cut power and control feeds to the charging station should a crash occur.

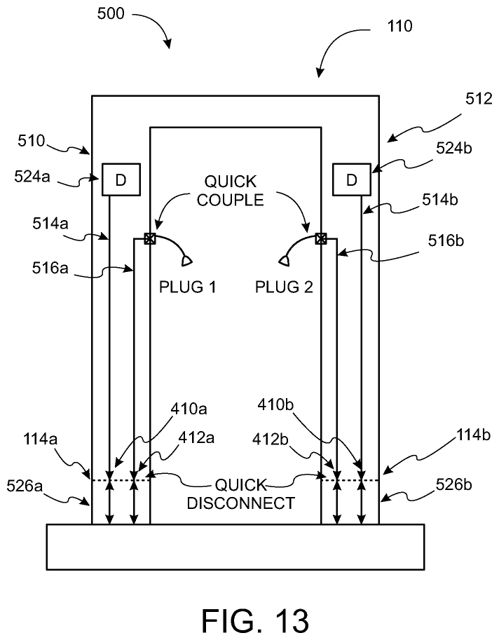

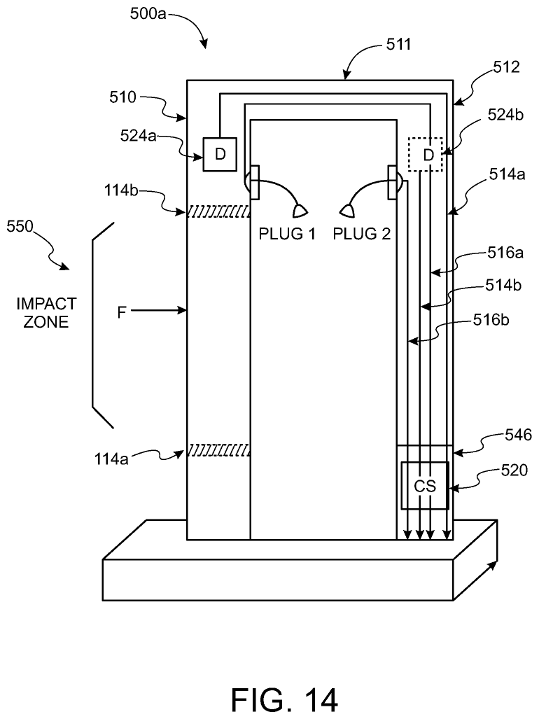

FIG. 13 is a diagram illustrating an electric vehicle charging station 500, according to examples of the present disclosure. The charging station 500 is a dual charging station that is capable of charging two electric vehicles at the same time. In other embodiments, charging station 500 is not a dual charging station. Charging station 500 includes a release mechanisms 114a,b. If an impact force were to occur, the charging station 500 separates only at the predetermined location of the release mechanisms 114a,b. This maintains the integrity of the charging station 500 and minimizes any damage to the charging station 500. Further, by locating the control system and other components/electronics to an area below the release mechanisms the components can be saved should an accident occur.

Charging station 500 has a generally U-shaped housing 110, and includes a housing first side 510 and housing second side 512. Housing first side 510 includes PLUG1 for charging an electric vehicle. Housing second side 512 includes PLUG2 for charging an electric vehicle. Further, housing first side 510 includes first side release mechanism 114a. Housing second side 512 includes second side release mechanism 114b.

In one example, housing first side 510 includes control cable 514a electrically coupled between display 524a and base unit 526a, where control cable 514a enters base unit 526a at quick disconnect 410a. Housing first side 510 includes power cable 516a electrically coupled between display PLUG1 and base unit 526a, where power cable 516a enters base unit 526a at quick disconnect 412a.

Housing second side 512 includes control cable 514b electrically coupled between display 524b and base unit 526b, where control cable 514b enters base unit 526b at quick disconnect 410b. Housing second side 512 includes power cable 516b electrically coupled between display PLUG2 and base unit 526b, where power cable 516b enters base unit 526b at quick disconnect 412b.

If an impact force to charging station 500 were to occur (e.g., due to a vehicle crash), the charging station 500 separates only at the predetermined location of the release mechanisms 114a,b. This maintains the integrity of the charging station 500 and minimizes any damage to the charging station 500. Additionally, power cables 516a,516b and control cables 514a,514b are immediately disabled and disconnected at base units 526a,526b. By locating the control system and other components/electronics to an area below the release mechanisms within the base units the components are protected should an accident occur.

FIG. 14 is a diagram illustrating an electric vehicle charging station 500a, according to examples of the present disclosure. The charging station 500a is similar to other charging stations described herein. The charging station 500a is a dual charging station that is capable of charging two electric vehicles at the same time. In other embodiments, charging station 500a is not a dual charging station. Charging station 500a includes a release mechanisms 114a,b. If an impact force were to occur, the charging station 500a separates only at the predetermined location of the release mechanisms 114a,b. This maintains the integrity of the charging station 500a and minimizes any damage to the charging station 500a. Further, by locating the control system and other components/electronics to an area below the release mechanisms the components can be saved should an accident occur.

Similar to charging station 500, Charging station 500a has a generally U-shaped housing 110, and includes a housing first side 510, housing top side 511, and housing second side 512. Housing first side 510 includes PLUG1 for charging an electric vehicle. Housing second side 512 includes PLUG2 for charging an electric vehicle. In one example, housing first side 510 includes first side release mechanism 114a and release mechanism 114b. Control cables 514a,514b and power cables 516a,516b are only routed through housing second side 512 (ie.e, and not housing first side 510). Control cable 514a and power cable 516a are routed to corresponding display 524a and PLUG1 through top side 511.

Release mechanism 114a and release mechanism 114b are located spaced apart on first side 510. In one example, crash force impact zone 550 is only located on first side 510. Release mechanism 114a and release mechanism 114b are located immediately outside of impact zone 500. This single sided charging station configuration may be desirable due to the location of the charging station. Upon occurrence of an impact force to impact zone 550, both release mechanisms sheer or separate the housing in the area of the impact zone from the rest of the charging station 500a. This predetermined response to an impact force within the impact zone (e.g., due to a vehicle crash), minimizes damage to the charging station 500a and virtually eliminates any damage to electronic and control components, control cables and power wiring which are all routed through second side 512. Control system 520 is located near the base of housing second side 512, and remains fully protected within base unit 546. In other examples, release mechanism 114a and release mechanism 114b can be located within impact zone 550.

Communication between control system 520 and display/user interfaces 524a, 524b can be wireless. This configuration results in no control wires/cables routed through housing 510, 511 and 512. Additionally, power cables 516a, 516b can be routed outside of the charging station 500a, including inside housing first side 510, top 511, and second side 512.

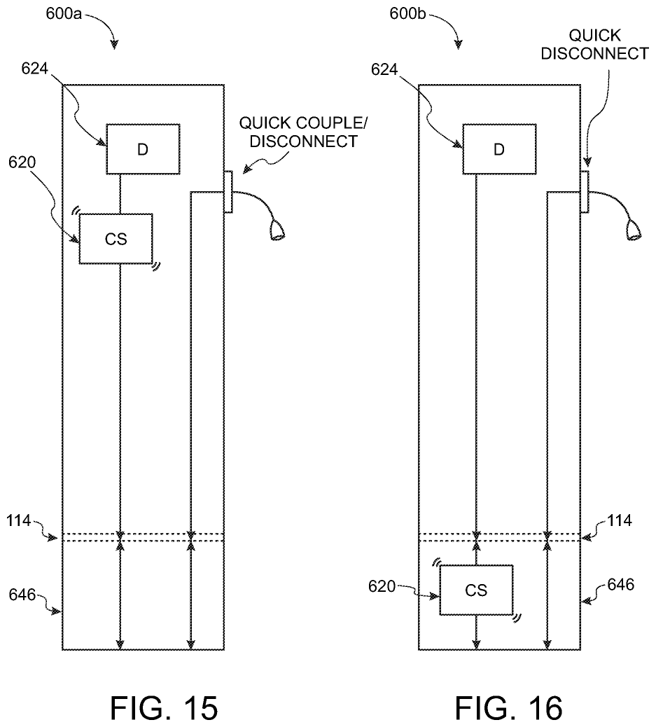

FIG. 15 and FIG. 16 are diagrams illustrating electric vehicle charging stations 600a, 600b, according to examples of the present disclosure. The charging station control system (e.g., control system 620 illustrated) can be located within base unit, or can be located in other areas of the charging stations. In FIG. 15, the charging station 600a control system 620 is located outside of base unit 646 near user interface 624. In FIG. 16, the charging station 600b control system 620 is located below release mechanism 114 and within base unit 646.

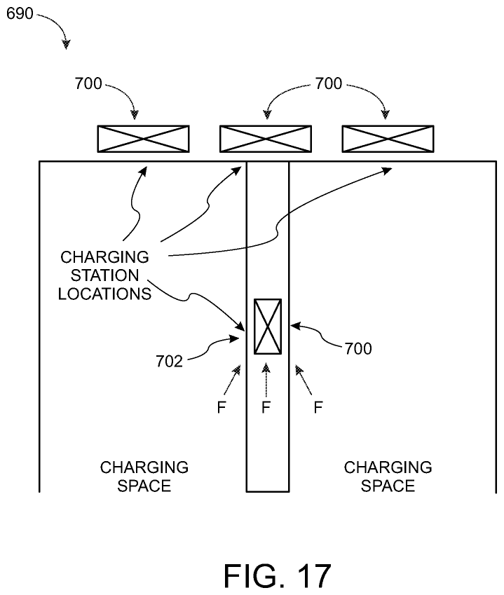

FIG. 17 is a diagram illustrating an electric vehicle charging facility 690, including one or more charging stations 700, according to examples of the present disclosure. The charging stations 700 are similar to the charging stations disclosed herein. The exact type of charging station with a release mechanism used may be dependent on the location of the charging station relative to the electric vehicle charging spaces, and where vehicle crashes may occur. For example, charging station 700 positioned at location 702 (e.g., positioned between one or more charging stations) could be configured similar to charging station 500. Other charging station configurations would also work, such as the configuration of charging stations 100, 200 or 300.

It is recognized that a charging station with a release mechanism can include one or more of the following features:
A housing having a release mechanism or sheer mechanism as part of the housing.
The release mechanism can be located below or above an auto contact (i.e., crash or bumper) zone of the charging station housing.
The release mechanism allows the charging station to release, sheer, partially break, or breakaway in a predetermined location and in a predetermined manner.
By breaking away in a predetermined location or predetermined manner, damage to the charging station is minimized or even avoided.
Power and control cables are quick coupled to the power and control feeds to the charging station, and also can quick release upon impact.
Power and control cables may be provided with a length of slack to enable the charging station to release without causing tension to be applied to the power and control cables.
Power and control to the charging station can be shutdown upon impact, with notification sent to the central control system via the on-board control system.

In one or more examples, the release mechanism is a weaker material, thinner portion or other mechanism located in a predetermined location of the charging station housing.
In one example, the release mechanism is located below the impact or crash zone of the charging station.
A single charging station may include multiple release mechanisms.
In one or more examples, power and control cables are not routed through predetermined impact/crash/bumper zones.
The charging station control system can be located below the impact zone, and below the release mechanism.
The charging station control system can be located above the impact zone.
The charging station physically and electrically disconnects upon impact.
The charging station plug has a quick couple disconnect at the housing for situations where the plug is coupled to the vehicle and pulled from the charging station.

It is recognized that the charging system of the present disclosure can be configured for use in many charging system applications, including those not disclosed herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. An electric vehicle charging station comprising:
a housing, where the housing is a longitudinally extending housing;
one or more charging components coupled to the housing; and
a release mechanism located along the housing; where upon impact to the housing the housing separates at the release mechanism.

2. The electric vehicle charging station of claim 1, where the release mechanism is formed integral the housing.

3. The electric vehicle of claim 1, where upon impact, the release mechanism separates the housing into two pieces.

4. The electric vehicle charging station of claim 1, comprising:
where the release mechanism electrically disconnects the charging station.

5. The electric vehicle charging station of claim 1, the release mechanism comprising a weakened area at a predefined location in the housing.

6. The electric vehicle charging station of claim 1, the release mechanism comprising a weakened plate coupled to the housing.

7. The electric vehicle of claim 6, where the plate is thinner than a wall of the housing.

8. The electric vehicle of claim 6, where the plate is made of a material different than the housing.

9. The electric vehicle of claim 6, where the plate is made of aluminum.

10. The electric vehicle of claim 1, where the release mechanism comprises a hinged member.

11. The electric vehicle of claim 1, where the release mechanism is made of a material different than the housing.

12. An electric vehicle charging station comprising:
a housing having a first end and a second end, and a longitudinally extending sidewall between the first end and the second end;
a user interface located proximate the first end;
a charging cable unit coupled to the housing;
a base unit located proximate the second end;
one or more charging components located within the housing; and
a release mechanism located in the sidewall between the first end and the second end.

13. The electric vehicle charging station of claim 12, the release mechanism comprising a breakaway mechanism formed integral the sidewall.

14. The electric vehicle charging station of claim 12, where the user interface is located between the release mechanism and the first end, and the base unit is located between the release mechanism and the second end.

15. The electric vehicle charging station of claim 12, the housing having a vehicle contact zone, where the release mechanism is located between the vehicle contact zone and the second end.

16. The electric vehicle charging station of claim 12, where the base unit comprises a charging station control system, and where the base unit is sealed at an interface between the base unit and the release mechanism.

17. The electric vehicle of claim 16, comprising power and control quick coupling device at an interface between the base unit and the release mechanism.

18. The electric vehicle charging station of claim 12, comprising:
a force detector located within the housing that detects the presence of an impact force to the housing, where upon detection of an impact force to the housing charging power and control power is disconnected from the charging station.

19. The electric vehicle charging station of claim 18, where the force detector comprises an accelerometer.

20. The electric vehicle charging station of claim 12 comprising:
the housing comprising an upper section and a lower section, the lower section comprising the base unit located at the second end and having a control system contained therein, a vehicle contact zone, and the release mechanism positioned between the base unit and the vehicle contact zone;
the housing upper section including the user interface, where the user interface is a graphical user interface; and
power and control quick couple devices are located between the base unit and the release mechanism.

21. An electric vehicle charging facility comprising:
a plurality of charging spaces; and
one or more charging stations located near the charging spaces, where at least one charging station comprises the electric vehicle charging station of claim 1.
